(19) United States
(12) Patent Application Publication
(10) Pub. No.: US 2011/0130948 A1
(43) Pub. Date: Jun. 2, 2011

(54) APPARATUS AND METHOD FOR MANAGING FLIGHT PLAN STATE FOR AIR TRAFFIC CONTROL

(75) Inventors: Seung-Hee Oh, Daejeon (KR); Jong-Wook Han, Daejeon (KR); Hyo-Dal Park, Seoul (KR); Do-Woo Kim, Daejeon (KR); Seoung-Hyeon Lee, Daejeon (KR); Deok-Gyu Lee, Yongin-si (KR)

(73) Assignee: ELECTRONICS AND TELECOMMUNICATIONS RESEARCH INSTITUTE, Daejeon (KR)

(21) Appl. No.: 12/907,504

(22) Filed: Oct. 19, 2010

(30) Foreign Application Priority Data
Dec. 1, 2009 (KR) 10-2009-0117897

(51) Int. Cl. G06F 19/00

(52) U.S. Cl. 701/120

(57) ABSTRACT

Disclosed are an apparatus and a method for managing a flight plan state for an air traffic control that manage the flight plan state by using time information and accurately manage departure and arrival states of an aircraft by utilizing a state processor only for departure/arrival. The apparatus for managing a flight plan state for an air traffic control includes: a flight plan managing device generating a flight plan list on the basis of an inputted flight plan and setting a flight plan state of the flight plan included in the flight plan list; and a departure/arrival managing device generating a departure-scheduled aircraft list and an arrival-scheduled aircraft list on the basis of the flight plan state of the aircraft set by the flight plan managing device and managing departure and arrival of the aircraft on the basis of the departure-scheduled aircraft list and the arrival-scheduled aircraft list.

### CROSS REFERENCE TO RELATED APPLICATIONS

This application claims priority to Korean Patent Application No. 10-2009-0117897 filed on Dec. 1, 2009, the entire contents of which are herein incorporated by reference.

### BACKGROUND OF THE INVENTION

1. Field of the Invention

The present invention relates to an apparatus and a method for managing a flight plan state for an air traffic control, and more particularly, to an apparatus and a method for managing a flight plan state for an air traffic control that rapidly and accurately process a civil aviation traffic volume that is rapidly increasing by receiving a flight plan and a repetitive flight plan submitted before an aircraft departs and automatically providing management of the flight plan state for the aircraft on the basis of time information.

2. Description of the Related Art

In general, an air traffic control means a service performed by the air traffic control service unit on take-off and landing sequences, times, and methods of all aircrafts on a ground or in flight for the purpose of preventing a collision between aircrafts, preventing a collision between the aircraft and an obstruction, and promoting air traffic and maintaining order of the air traffic. The air traffic control is classified into an aerodrome control which is a control service for aircrafts operating around a movement area in an airport and an aerodrome and persons who engages in a service in the corresponding aerodrome, an approach control which is a control service performed with respect to an instrument flight aircraft that arrives at and departs from a jurisdiction airport positioned in an approach control area, and an air route control which is a control service separating aircrafts from each other and providing information with respect to an instrument flight aircraft which is flying on an air route, etc.

In recent years, the air traffic volume is increasing due to an increase in the number of small-size airplanes, personal air vehicles, etc. in addition to large-size airplanes of an airline. As the air traffic volume increases, incident rate of an aviation accident at the airport is increasing. As a result, the importance of the air traffic control has increased, thus, a technology for improving the accuracy of the air traffic control is required.

However, in an air traffic control in the prior art, since the air traffic control depending on a departure time of the aircraft included in a flight plan is performed, the accuracy of the air traffic control is decreased, thus, causing an increase in uneasiness of a boarder.

Further, accurate management information of a flight plan state of an aircraft which departs and arrives is not provided in the air traffic control, such that a holding time of the aircraft is increased and as a result, flight fuel and time are wasted.

Accordingly, a technology for rapidly and accurately providing the management information of the flight plan state of the aircraft which departs and arrives is required to assist the accurate air traffic control.

### SUMMARY OF THE INVENTION

The present invention is contrived to solve the above-mentioned problems and there is an object of the present invention to provide an apparatus and a method for managing a flight plan state for an air traffic control that manage the flight plan state by using time information and accurately manage departure and arrival states of an aircraft by utilizing a state processor only for departure/arrival.

In order to achieve the above-mentioned object, according to an aspect of the present invention, there is provided an apparatus for managing a flight plan state for an air traffic control that includes: a flight plan managing device generating a flight plan list on the basis of an inputted flight plan and setting a flight plan state of the flight plan included in the flight plan list; and a departure/arrival managing device generating a departure-scheduled aircraft list and an arrival-scheduled aircraft list on the basis of the flight plan state of the aircraft set by the flight plan managing device and managing departure and arrival of the aircraft on the basis of the departure-scheduled aircraft list and the arrival-scheduled aircraft list.

The flight plan managing device sets any one of a standby state, an activation state, a termination state, and a discarding/deleting state as the flight plan state.

The flight plan managing device sets the inputted flight plan to the standby state and adds it to the flight plan list.

The apparatus for managing a flight plan state for an air traffic control further includes a flight plan timer determining whether or not the flight plan included in the flight plan list is validation on the basis of validation condition information including an validation period, an validation day of the week, and an validation time.

The flight plan managing device sets the flight plan state of the flight plan determined to be validation by the flight plan timer to the activation state.

The departure/arrival managing device generates the departure-scheduled aircraft list and the arrival-scheduled aircraft list by detecting the flight plan set to the activation state among the flight plans included in the flight plan list.

The departure/arrival managing device determines whether or not an aircraft included in the departure-scheduled aircraft list actually departs on the basis of an inputted actual aircraft departure time and deletes a flight plan corresponding to the aircraft determined to actually depart from the departure-scheduled aircraft list.

The departure/arrival managing device determines whether or not an aircraft included in the arrival-scheduled aircraft list actually arrives on the basis of an inputted actual aircraft arrival time and deletes a flight plan corresponding to the aircraft determined to actually arrive from the arrival-scheduled aircraft list.

The flight plan managing device deletes the corresponding flight plan from the flight plan list when the flight plan corresponding to the aircraft determined to actually arrive by the departure/arrival managing device is a general flight plan and sets the corresponding flight plan to the standby state when the flight plan corresponding to the aircraft determined to actually arrive by the departure/arrival managing device is a repetitive flight plan.

The apparatus for managing a flight plan state for an air traffic control further includes an input device receiving at least one of the flight plan, the actual aircraft departure time, and the actual aircraft arrival time.

In order to achieve the above-mentioned object, according to another aspect of the present invention, there is provided a method for managing a flight plan state for an air traffic control that includes: generating a flight plan list on the basis of an inputted flight plan by a flight plan managing device; setting a flight plan state of the flight plan included in the flight plan list generated at the generating a flight plan list by the flight plan managing device; generating a departure-scheduled aircraft list and an arrival-scheduled aircraft list on the basis of the flight plan state of the aircraft set by the setting a flight plan state by a departure/arrival managing device; and managing departure and arrival of the aircraft on the basis of the departure-scheduled aircraft list and the arrival-scheduled aircraft list generated at the generating departure and arrival-scheduled aircraft lists by the departure/arrival managing device.

At the setting a flight plan state, any one of a standby state, an activation state, a termination state, and a discarding/deleting state is set as the flight plan state by flight plan managing device.

At the generating a flight plan list, the inputted flight plan is set to the standby state and added to the flight plan list by the flight plan managing device.

The method for managing a flight plan state for an air traffic control further includes determining whether or not the flight plan included in the flight plan list is validation on the basis of validation condition information including an validation period, an validation day of the week, and an validation time by a flight plan timer.

At the setting a flight plan state, the flight plan state of the flight plan determined to be validation at the determining is set to the activation state by the flight plan managing device.

At the generating departure and arrival-scheduled aircraft lists, the departure-scheduled aircraft list and the arrival-scheduled aircraft list are generated by detecting the flight plan set to the activation state among the flight plans included in the flight plan list by the departure/arrival managing device.

At the managing departure and arrival of the aircraft, whether or not an aircraft included in the departure-scheduled aircraft list actually departs is determined on the basis of an inputted actual aircraft departure time and a flight plan corresponding to the aircraft determined to actually depart is deleted from the departure-scheduled aircraft list by the departure/arrival managing device.

At the managing departure and arrival of the aircraft, whether or not an aircraft included in the arrival-scheduled aircraft list actually arrives is determined on the basis of an inputted actual aircraft arrival time and a flight plan corresponding to the aircraft determined to actually arrive is deleted from the arrival-scheduled aircraft list by the departure/arrival managing device.

At the managing departure and arrival of the aircraft, the corresponding flight plan is deleted from the flight plan list when the flight plan corresponding to the aircraft determined to actually arrive by the departure/arrival managing device is a general flight plan and the corresponding flight plan is set to the standby state when the flight plan corresponding to the aircraft determined to actually arrive by the departure/arrival managing device is a repetitive flight plan, by the flight plan managing device.

The method for managing a flight plan state for an air traffic control further includes receiving at least one of the flight plan, the actual aircraft departure time, and the actual aircraft arrival time by an input device.

According to an embodiment of the present invention, an apparatus and a method for managing a flight plan state for an air traffic control can improve the accuracy of the air traffic control and prevent a flight accident which may occur on a runway with accurate and up-to-date information on an aircraft that departs and arrives by providing accurate flight plan state management information on the aircraft.

Further, the apparatus and the method for managing a flight plan state for an air traffic control can minimize a holding time which the aircraft wastes over an airport in order to ensure a runway by providing accurate and up-to-date information on an aircraft which departs and arrives.

Incidentally, the apparatus and the method for managing a flight plan state for an air traffic control can minimize wastes of flight fuel and time consumed due to holding of the aircraft by minimizing the holding time of the aircraft.

In addition, the apparatus and the method for managing a flight plan state for an air traffic control can expect an effect of creating a safe and reliable atmosphere at the time of operating and using the aircraft.

### BRIEF DESCRIPTION OF THE DRAWINGS

FIG. 1 is a block diagram for describing an apparatus for managing a flight plan state for an air traffic control according to an embodiment of the present invention;

FIG. 2 is a diagram for describing a flight plan management device of FIG. 1;

FIG. 3 is a diagram for describing a flight plan timer of FIG. 1;

FIG. 4 is a diagram for describing a departure and arrival management device of FIG. 1;

FIG. 5 is a flowchart for describing a method for managing a flight plan state for an air traffic control according to an embodiment of the present invention;

FIG. 6 is a flowchart for describing a flight plan registering step of FIG. 5;

FIG. 7 is a flowchart for describing a flight plan state managing step of FIG. 5;

FIG. 8 is a flowchart for describing a departure-scheduled aircraft managing step of FIG. 2; and

FIG. 9 is a flowchart for describing an arrival-scheduled aircraft managing step of FIG. 2.

### DETAILED DESCRIPTION OF THE PREFERRED EMBODIMENTS

Hereinafter, the exemplary embodiments of the present invention will be described in detail with reference to the accompanying drawings. The exemplary embodiments of the present invention to be described below are provided so that those skilled in the art to which the present invention pertains can fully carry out the present invention. Therefore, the present invention may be modified in many different forms and it should not be limited to the embodiments set forth herein. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention.

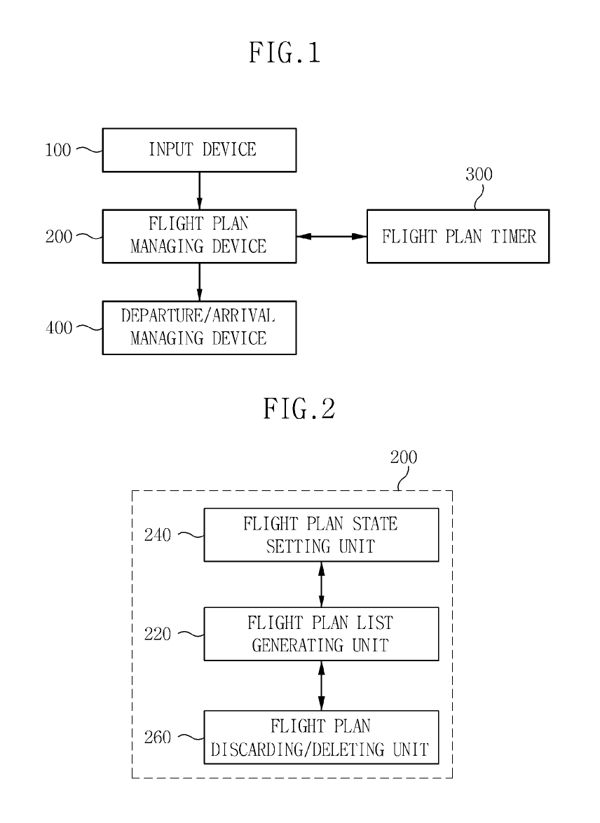

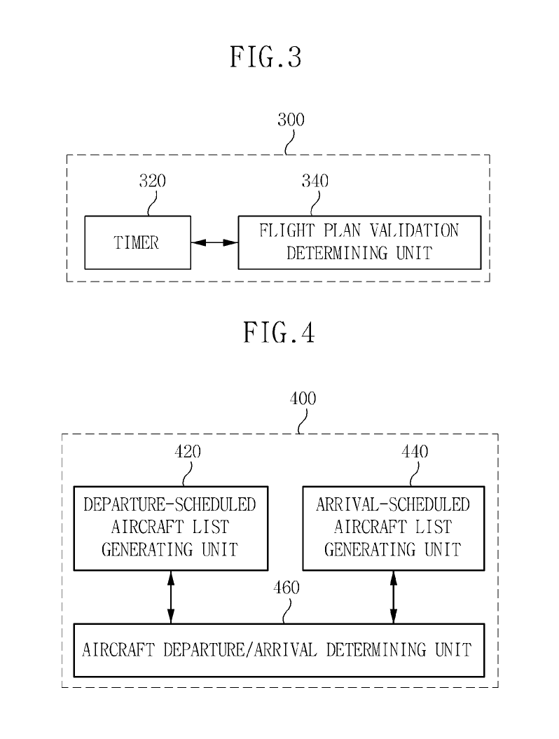

Hereinafter, a method for managing a flight plan state for an air traffic control according to an embodiment of the present invention will be described in detail with reference to the accompanying drawings. FIG. 1 is a block diagram for describing an apparatus for managing a flight plan state for an air traffic control according to an embodiment of the present invention. FIG. 2 is a diagram for describing a flight plan management device of FIG. 1, FIG. 3 is a diagram for describing a flight plan timer of FIG. 1, and FIG. 4 is a diagram for describing a departure and arrival management device of FIG. 1. First, prior to describing the embodiment of the present invention, in the case of application fields of the present invention, the present invention is applied to an aircraft state management function in an air traffic control system installed in domestic and foreign civil aircraft airports and an air traffic control system managed and used in the Air Force. Further, the present invention may also be utilized in an air traffic controller training system, an air simulation related system, and a marine traffic control field.

As shown in FIG. 1, the apparatus for managing a flight plan state for an air traffic control includes an input device 100, a flight plane managing device 200, a flight plan timer 300, and a departure and arrival managing device 400.

The input device 100 receives at least one of a flight plan, and an actual aircraft departure time and an actual aircraft arrival time which are the bases of flight plan management. That is, the input device 100 receives a flight plan including an origin, a destination, a departure date, an arrival date, aircraft information (e.g., flight No., an airline, etc.), etc. The input device 100 receives the actual departure time determined depending on an airport state and weather information (e.g., weather, a wind direction, a wind speed, etc.) of the origin, an aircraft condition, etc. The input device 100 receives the actual aircraft arrival time determined depending on an airport state and weather information (e.g., weather, a wind direction, a wind speed, etc.) of the destination, an aircraft condition, etc.

The flight plan managing device 200 generates a flight plan list on the basis of the inputted flight plan and sets a flight plan state of the fight plan included in the flight plan list. For this, as shown in FIG. 2, the flight plan managing device 200 includes a flight plan list generating unit 220 generating the flight plan list, a flight plan state setting unit 240 setting the flight plan state to a standby state, an activation state, a termination state, etc. depending on a state change of the flight plan, and a flight plan discarding/deleting unit 260 deleting or discarding the flight plan from the flight plan list.

The flight plan managing device 200 generates the flight plan list on the basis of the flight plan inputted through the input device 100. At this time, the flight plan managing device 200 sets the flight plan state of the flight plan inputted through the input device 100 to the standby state and adds the corresponding flight plan to the flight plan list.

The flight plan managing device 200 manages the flight plan state of the flight plan included in the fight plan list. The flight plan managing device 200 sets any one of the standby state, the activation state, the termination state, and the discard/deleting state as the flight plan state with respect to the flight plan included in the flight plan list. At this time, the flight plan managing device 200 changes the flight plan state of the flight plan determined to be validation in the flight plane timer 300 from the standby state to the activation state.

The flight plan managing device 200 changes a flight plant state of a flight plan corresponding to an aircraft determined to actually arrive in the departure/arrival managing device 400. That is, when an aircraft corresponding to a general flight plan arrives and the departure/arrival managing device 400 determines that the aircraft actually arrives, the flight plan managing device 200 deletes (discards) the corresponding flight plan from the flight plan list. When an aircraft corresponding to a repetitive flight plan arrives and the departure/arrival managing device 400 determines that the aircraft actually arrives, the flight plan managing device 200 changes the flight plan state of the corresponding flight plan stored in the flight plan list to the standby state.

The flight plan timer 300 determines validation of the flight plan on the basis of validation condition information. That is, the flight plan timer 300 determined whether or not the flight plan included in the flight plan list is validation on the basis of the validation condition information including an validation period, an validation day of the week, and an validation time. For this, the flight plan timer 300 includes a timer 320 verifying time information used as the validation condition information and a flight plan validation determining unit 340 determining whether or not the flight plan included in the flight plan list is validation on the basis of the validation condition information. At this time, verification of the time information performed by the flight plan timer 300 is divided into verification of the validation period, verification of the corresponding flight day of the week, and verification of a flight departure time.

The departure/arrival managing device 400 generates a departure-scheduled aircraft list and an arrival-scheduled aircraft list on the basis of the flight plan state of the aircraft set in the flight plan managing device 200 and manages departure and arrival of the aircraft on the basis of the departure-scheduled aircraft list and the arrival-scheduled aircraft list. For this, as shown in FIG. 4, the departure/arrival managing device 400 a departure-scheduled aircraft list generating unit 420 added to the departure-scheduled aircraft list by detecting the flight plan under the activation state among the flight plans included in the flight plan list, an arrival-scheduled aircraft list generating unit 440 added to the arrival-scheduled aircraft list by detecting the flight plan under the activation state among the flight plans included in the flight plan list, and an aircraft departure/arrive determining unit 460 determining departure or arrival of the aircraft on the basis of an actual aircraft departure time and an actual aircraft arrival time.

The departure/arrival managing device 400 generates the departure-scheduled aircraft list and the departure-scheduled aircraft list by detecting the flight plan set to the activation state among the flight plans included in the flight plan list. That is, the departure/arrive managing device 400 receives the flight plan under the activation state from the flight plan managing device 200 to create and manage the departure-scheduled aircraft list and the arrival-scheduled aircraft list on the basis of a predetermined time (i.e., one hour before) in the entire system.

The departure/arrival managing device 400 determines whether or not an aircraft included in the departure-scheduled aircraft list actually departs on the basis of the inputted actual aircraft departure time and determines whether or not an aircraft included in the arrival-scheduled aircraft list actually arrives on the basis of the inputted actual aircraft arrival time. At this time, the actual aircraft departure time and the actual aircraft arrival time are determined depending on an airport conditions, weather information (i.e., weather, a wind direction, a wind speed, etc.), aircraft conditions, etc., and inputted through the input device 100.

The departure/arrival managing device 400 deletes a flight plan corresponding to an aircraft determined to actually depart or actually arrive from the departure-scheduled aircraft list or the arrival-scheduled aircraft list. That is, the departure/arrival managing device 400 deletes the flight plan corresponding to the aircraft determined to actually depart from the departure-scheduled aircraft list and deletes the flight plan corresponding to the aircraft determined to actually arrive from the arrival-scheduled aircraft list.

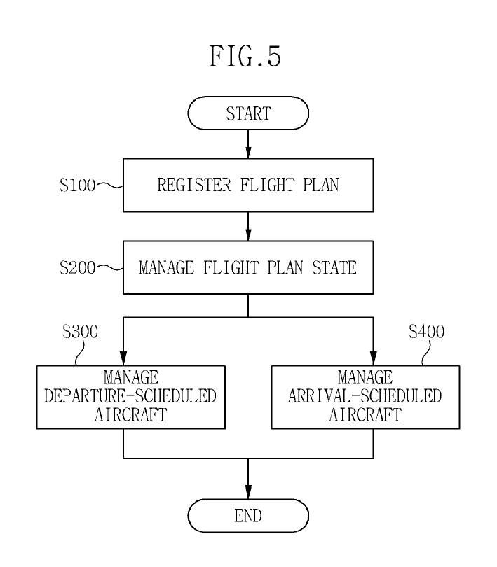

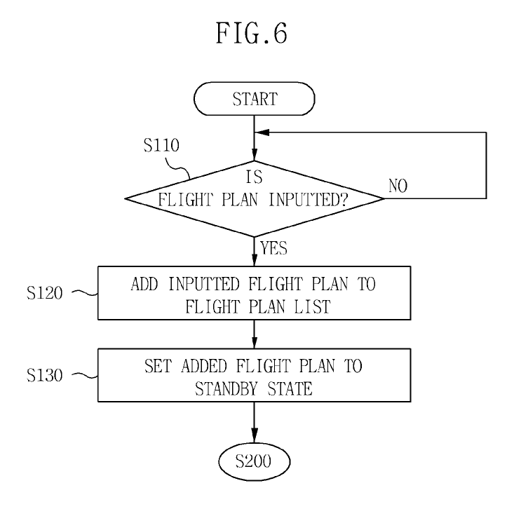

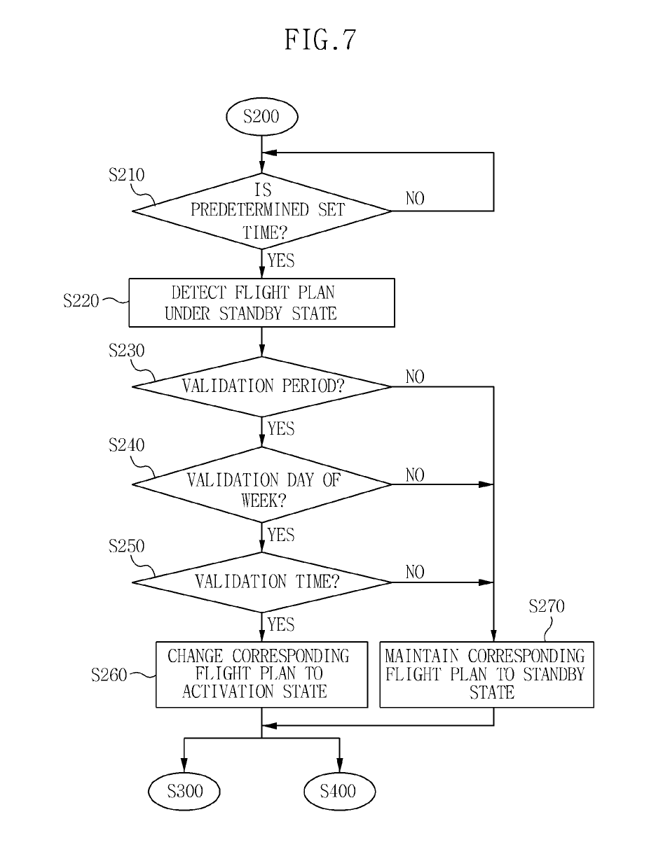

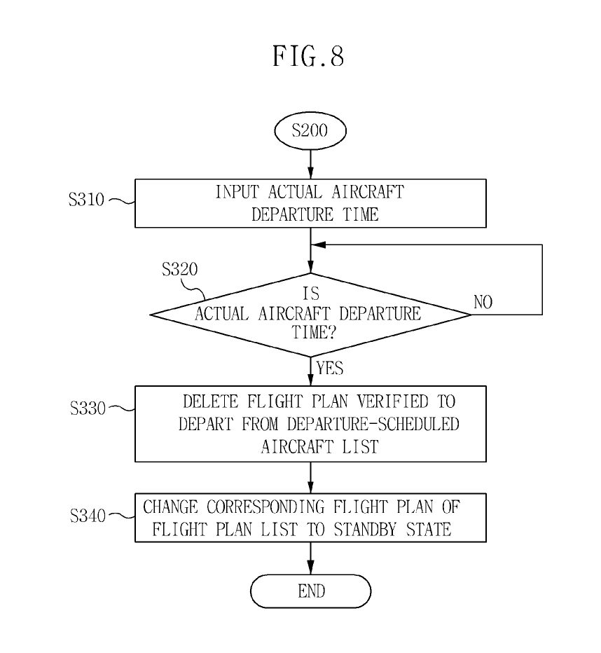

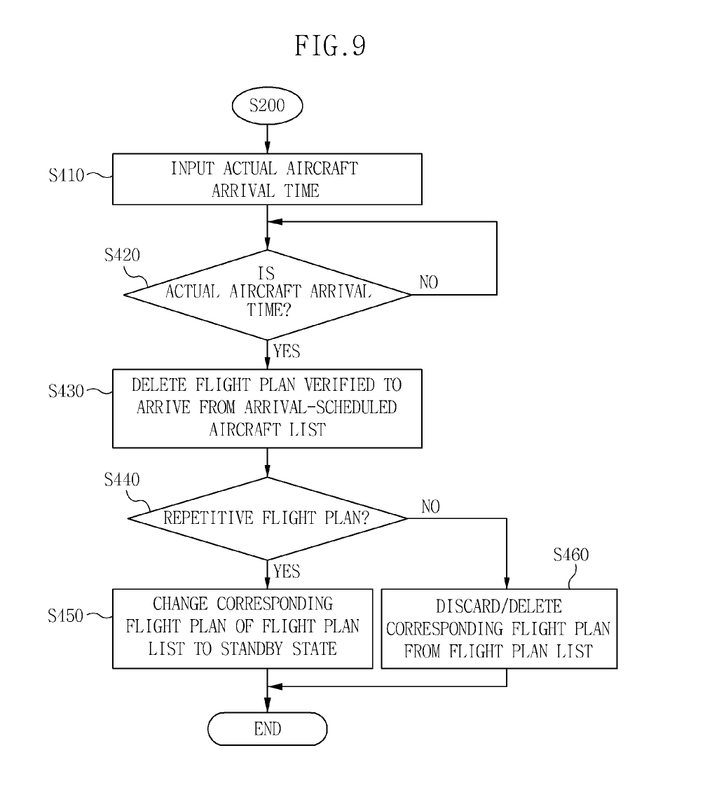

Hereinafter, a method for managing a flight plan state for an air traffic control according to an embodiment of the present invention will be described in detail with reference to the accompanying drawings. FIG. 5 is a flowchart for describing a method for managing a flight plan state for an air traffic control according to an embodiment of the present invention. FIG. 6 is a flowchart for describing a flight plan registering step of FIG. 5, FIG. 7 is a flowchart for describing a flight plan state managing step of FIG. 5, FIG. 8 is a flowchart for describing a departure-scheduled aircraft managing step of FIG. 2, and FIG. 9 is a flowchart for describing an arrival-scheduled aircraft managing step of FIG. 2.

First, an apparatus for managing a flight plan state for an air traffic control registers a flight plan provided from an aircraft of which flight is scheduled (or an aircraft operating company, a pilot, etc.) (S100). As shown in FIG. 6, at the flight plan registering step, when the flight plan for the corresponding aircraft is inputted from the aircraft (or the aircraft operating company, the pilot, etc.) through the input device 100 (S110; YES), the flight plan managing device 200 adds the inputted flight plan to the flight plan list (S120). At this time, the flight plan managing device 200 first generates the flight plan list when no flight plan list is generated and thereafter, adds the inputted flight plan to the flight plan list. The flight plan managing device 200 sets the corresponding flight plan to a standby state when addition of the flight plan is completed (S130).

The apparatus for managing a flight plan state for an air traffic control performs the flight plan managing step of the registered flight plan (S200). As shown in FIG. 7, at the flight plan state managing step, when current time is a predetermined set time (e.g., approximately one hour) for management of the flight plan (S210; YES), a flight plan timer 300 detects the flight plan under the standby state among the flight plans included in the flight plan list (S220). As shown in FIG. 7, at the flight plan managing step, the flight plan timer 300 determines whether or not an validation period arrives by comparing the validation period of the detected flight plan with current time information. When the validation period arrives (S230; YES), the flight plan timer 300 compares a departure (or arrival) day of the week of the detected flight plan with a current day of the week to determine whether the corresponding day of the week is validation. When the fight plan timer 300 determines that the corresponding day of the week is validation (S240; YES), the flight plan timer 300 compares a departure time (or arrival time) of the detected flight plan with a current time to determine whether or not the corresponding time is validation. When the flight plan timer determines that the corresponding time is validation (S250; YES), the flight plan timer 300 determines that the corresponding flight plan is validation. As a result, a flight plan managing device changes a flight plan state of the flight plan determined to be validation by the flight plan timer 300 to an activation state (S260). The flight plan managing device maintains a flight plan state of the flight plan determined to be invalidation by the flight plan timer 300 under a standby state (S270).

The apparatus for managing a flight plan state for an air traffic control performs a departure-scheduled aircraft managing step as a departure-scheduled aircraft departs from the airport (S300). As shown in FIG. 8, at the departure-scheduled aircraft managing step, the input device 100 receives the actual aircraft departure time from the aircraft which is scheduled to depart (or the aircraft operating company, the pilot, etc.) (S310). A departure/arrival managing device 400 receives the current time from the flight plan timer 300 and compares the current time with the actual aircraft departure time inputted through the input device 100 to determine whether or not the actual aircraft departure time arrives. At this time, when the actual aircraft departure time inputted through the input device 100 is actual aircraft departure time (S320; YES), the departure/arrival managing device 400 deletes a flight plan corresponding to an aircraft of which departure is verified from the departure-scheduled aircraft list (S330). The flight plan managing device 200 changes the flight plan state of the flight plan corresponding to the aircraft of which departure is verified among the flight plans included in the flight plan list to the standby state (S340).

The apparatus for managing a flight plan state for an air traffic control performs an arrival-scheduled aircraft managing step as an arrival-scheduled aircraft departs from the airport (S400). As shown in FIG. 9, at the arrival-scheduled aircraft managing step, the input device 100 receives the actual aircraft arrival time from the aircraft which is scheduled to arrive (or the aircraft operating company, the pilot, etc.) (S410). The departure/arrival managing device 400 receives the current time from the flight plan timer 300 and compares the current time with the actual aircraft arrival time inputted through the input device 100 to determine whether or not the actual aircraft arrival time arrives. At this time, when the actual aircraft departure time inputted through the input device 100 is actual aircraft arrive time (S420; YES), the departure/arrival managing device 400 deletes a flight plan corresponding to an aircraft of which arrival is verified from the arrival-scheduled aircraft list (S430). The flight plan managing device 200 verifies whether or not the flight plan of the aircraft that arrives is the repetitive flight plan. When the flight plan managing device 200 verifies that the corresponding flight plan is the repetitive flight plan (S450; YES), the flight plan managing device 200 changes the flight plan corresponding to the aircraft that arrives among the flight plans included in the flight plan list to the standby state (S450). At this time, the flight plan managing device 200 discards/deletes the flight plan corresponding to the aircraft that arrives among the flight plans included in the flight plan list when the flight plan of the aircraft that arrives is the repetitive flight plan (S460).

As described above, an apparatus and a method for managing a flight plan state for an air traffic control can improve the accuracy of the air traffic control and prevent a flight accident which may occur on a runway with accurate and up-to-date information on an aircraft that takes off and lands by providing accurate flight plan state management information on the aircraft.

Further, the apparatus and the method for managing a flight plan state for an air traffic control can minimize a holding time which the aircraft wastes over an airport in order to ensure a runway by providing accurate and up-to-date information on an aircraft which departs and lands.

Incidentally, the apparatus and the method for managing a flight plan state for an air traffic control can minimize wastes of flight fuel and time consumed due to holding of the aircraft by minimizing the holding time of the aircraft.

In addition, the apparatus and the method for managing a flight plan state for an air traffic control can expect an effect of creating a safe and reliable atmosphere at the time of operating and using the aircraft.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for managing a flight plan state for an air traffic control, comprising:
a flight plan managing device generating a flight plan list on the basis of an inputted flight plan and setting a flight plan state of the flight plan included in the flight plan list; and
a departure/arrival managing device generating a departure-scheduled aircraft list and an arrival-scheduled aircraft list on the basis of the flight plan state of the aircraft set by the flight plan managing device and managing departure and arrival of the aircraft on the basis of the departure-scheduled aircraft list and the arrival-scheduled aircraft list.

2. The apparatus for managing a flight plan state for an air traffic control according to claim 1, wherein the flight plan managing device sets any one of a standby state, an activation state, a termination state, and a discarding/deleting state as the flight plan state.

3. The apparatus for managing a flight plan state for an air traffic control according to claim 1, wherein the flight plan managing device sets the inputted flight plan to the standby state and adds it to the flight plan list.

4. The apparatus for managing a flight plan state for an air traffic control according to claim 1, further comprising a flight plan timer determining whether or not the flight plan included in the flight plan list is validation on the basis of validation condition information including an validation period, an validation day of the week, and an validation time.

5. The apparatus for managing a flight plan state for an air traffic control according to claim 4, wherein the flight plan managing device sets the flight plan state of the flight plan determined to be validation by the flight plan timer to the activation state.

6. The apparatus for managing a flight plan state for an air traffic control according to claim 5, wherein the departure/arrival managing device generates the departure-scheduled aircraft list and the arrival-scheduled aircraft list by detecting the flight plan set to the activation state among the flight plans included in the flight plan list.

7. The apparatus for managing a flight plan state for an air traffic control according to claim 1, wherein the departure/arrival managing device determines whether or not an aircraft included in the departure-scheduled aircraft list actually departs on the basis of an inputted actual aircraft departure time and deletes a flight plan corresponding to the aircraft determined to actually depart from the departure-scheduled aircraft list.

8. The apparatus for managing a flight plan state for an air traffic control according to claim 1, wherein the departure/arrival managing device determines whether or not an aircraft included in the arrival-scheduled aircraft list actually arrives on the basis of an inputted actual aircraft arrival time and deletes a flight plan corresponding to the aircraft determined to actually arrive from the arrival-scheduled aircraft list.

9. The apparatus for managing a flight plan state for an air traffic control according to claim 8, wherein the flight plan managing device deletes the corresponding flight plan from the flight plan list when the flight plan corresponding to the aircraft determined to actually arrive by the departure/arrival managing device is a general flight plan and sets the corresponding flight plan to the standby state when the flight plan corresponding to the aircraft determined to actually arrive by the departure/arrival managing device is a repetitive flight plan.

10. The apparatus for managing a flight plan state for an air traffic control according to claim 1, further comprising an input device receiving at least one of the flight plan, the actual aircraft departure time, and the actual aircraft arrival time.

11. A method for managing a flight plan state for an air traffic control, comprising:
generating a flight plan list on the basis of an inputted flight plan by a flight plan managing device;
setting a flight plan state of the flight plan included in the flight plan list generated at the generating a flight plan list by the flight plan managing device;
generating a departure-scheduled aircraft list and an arrival-scheduled aircraft list on the basis of the flight plan state of the aircraft set by the setting a flight plan state by a departure/arrival managing device; and
managing departure and arrival of the aircraft on the basis of the departure-scheduled aircraft list and the arrival-scheduled aircraft list generated at the generating departure and arrival-scheduled aircraft lists by the departure/arrival managing device.

12. The method for managing a flight plan state for an air traffic control according to claim 11, wherein at the setting a flight plan state, any one of a standby state, an activation state, a termination state, and a discarding/deleting state is set as the flight plan state by flight plan managing device.

13. The method for managing a flight plan state for an air traffic control according to claim 11, wherein at the generating a flight plan list, the inputted flight plan is set to the standby state and added to the flight plan list by the flight plan managing device.

14. The method for managing a flight plan state for an air traffic control according to claim 11, further comprising determining whether or not the flight plan included in the flight plan list is validation on the basis of validation condition information including an validation period, an validation day of the week, and an validation time by a flight plan timer.

15. The method for managing a flight plan state for an air traffic control according to claim 14, wherein at the setting a flight plan state, the flight plan state of the flight plan determined to be validation at the determining is set to the activation state by the flight plan managing device.

16. The method for managing a flight plan state for an air traffic control according to claim 15, wherein at the generating departure and arrival-scheduled aircraft lists, the departure-scheduled aircraft list and the arrival-scheduled aircraft list are generated by detecting the flight plan set to the activation state among the flight plans included in the flight plan list by the departure/arrival managing device.

17. The method for managing a flight plan state for an air traffic control according to claim 11, wherein at the managing departure and arrival of the aircraft, whether or not an aircraft included in the departure-scheduled aircraft list actually departs is determined on the basis of an inputted actual aircraft departure time and a flight plan corresponding to the aircraft determined to actually depart is deleted from the departure-scheduled aircraft list by the departure/arrival managing device.

18. The method for managing a flight plan state for an air traffic control according to claim 11, wherein at the managing departure and arrival of the aircraft, whether or not an aircraft included in the arrival-scheduled aircraft list actually arrives is determined on the basis of an inputted actual aircraft arrival time and a flight plan corresponding to the aircraft determined to actually arrive is deleted from the arrival-scheduled aircraft list by the departure/arrival managing device.

19. The method for managing a flight plan state for an air traffic control according to claim 18, wherein at the managing departure and arrival of the aircraft, the corresponding flight plan is deleted from the flight plan list when the flight plan corresponding to the aircraft determined to actually arrive by the departure/arrival managing device is a general flight plan and the corresponding flight plan is set to the standby state when the flight plan corresponding to the aircraft determined to actually arrive by the departure/arrival managing device is a repetitive flight plan, by the flight plan managing device.

20. The method for managing a flight plan state for an air traffic control according to claim 11, further comprising receiving at least one of the flight plan, the actual aircraft departure time, and the actual aircraft arrival time by an input device.
